(19) United States
(12) Patent Application Publication
(10) Pub. No.: US 2003/0034726 A1
(43) Pub. Date: Feb. 20, 2003

(54) Color cathode -ray tube and method of manufacturing the same

(76) Inventor: Kimiyo Ibaraki, Inazawa (JP)

Correspondence Address: Ronald P. Kananen, RADER, FISHMAN & GRAUER, PLLC, Suite 501, N.W., 1233 20th Street, Washington, DC, 20036, US

(21) Appl. No.: 10/254,840

(22) Filed: Sep. 26, 2002

Related U.S. Application Data
(62) Division of application No. 09/600,139, filed on Sep. 12, 2000.

(30) Foreign Application Priority Data
Nov. 13, 1998 (JP) 10-323462

(51) Int. Cl. B05D 5/12; H01J 29/10

(52) U.S. Cl. 313/466; 427/68; 313/473

(57) ABSTRACT

A heat absorbing film (14) made of an oxide is formed on a conductive reflecting film (13) by applying and baking a sol containing a material, which is to form the oxide, in a colloidal state. Conditions under which a vacuum evaporation system for forming the conductive reflecting film (13), and an applying/baking system for forming the heat absorbing film (14) are operated need not be changed, and the heat absorbing film (14) having small variations in thickness and quality can be formed on the conductive reflecting film (13). Reflection and radiation of heat from the conductive reflecting film (13) to a color selection electrode are suppressed effectively, so that a color cathode-ray tube in which a decrease in color purity is small can be manufactured.

### TECHNICAL FIELD

The present invention relates to a color cathode-ray tube having conductive reflecting films on the phosphor screen of the inner surface of a panel and a color selection electrode, and a method of manufacturing the same.

### BACKGROUND ART

FIG. 1 shows a panel for a color cathode-ray tube. A phosphor screen 12 comprised of red, green and blue phosphor stripes and carbon films filling gaps among them is formed on the inner surface of a panel 11. Electron beams (not shown) are selectively landed on the phosphor stripes of predetermined colors of the phosphor screen 12 through a color selection electrode (not shown) to display a color image.

In order to reflect light, emerging from the phosphor screen 12 toward an electron gun (not shown), toward the panel 11 so as to increase the brightness, and to stabilize the potential of the phosphor screen 12, a conductive reflecting film 13 called a metal back, which is made of aluminum having a high light reflectance and electron transmittance, is formed on the phosphor screen 12.

The conductive reflecting film 13 made of aluminum also has high heat reflectance. If the conductive reflecting film 13 is exposed, heat radiated by the color selection electrode heated by bombardment of an electron beam is reflected by the conductive reflecting film 13 to further heat the color selection electrode.

When the color selection electrode is heated and thermally expands, the correspondence relationship between the color selection electrode and phosphor stripes fluctuates, and the electron beam is landed on an incorrect portion of the phosphor screen 12 to decrease the color purity. For this reason, conventionally, a heat absorbing film 14 is formed on the conductive reflecting film 13. Heat radiated from the color selection electrode is absorbed by the heat absorbing film 14. Heat reflection and radiation from the conductive reflecting film 13 to the color selection electrode are suppressed, thereby suppressing thermal expansion of the color selection electrode.

In a method of manufacturing a color cathode-ray tube having such a heat absorbing film 14 according to the first related art, a conductive reflecting film 13 is formed on a phosphor screen 12 by vapor deposition of aluminum in a vacuum of about 10⁻² to 10⁻³ Pa (10⁻⁴ to 10⁻⁵ Torr). After that, a black aluminum film serving as the heat absorbing film 14 is formed by vapor deposition of aluminum in a vacuum of 10 to 1 Pa (10⁻¹ to 10⁻² Torr) (Japanese Patent Publication No. 6247341).

In the second related art, a black aluminum film to serve as a heat absorbing film 14 is formed on a conductive reflecting film 13 by vacuum deposition using a mixed pellet of manganese and aluminum (Japanese Patent Publication No. 718001). In the third related art, a solution obtained by dissolving carbon in an organic solvent is sprayed to form a carbon film serving as a heat absorbing film 14 on a conductive reflecting film 13 (Japanese Patent Publication No. 5847813).

In the first related art described above, the vacuum degree in an evaporation system must be changed between formation of the conductive reflecting film 13 and formation of the heat absorbing film 14. A desired vacuum degree cannot be precisely obtained, or oil in the exhaust pump may be oxidized, leading to variations in thickness and quality of the heat absorbing film 14. Therefore, heat reflection and radiation from the conductive reflecting film 13 to the color selection electrode cannot be suppressed effectively, and mislanding of the electron beam onto the phosphor screen 12 due to thermal expansion of the color selection electrode is difficult to suppress, making it difficult to manufacture a color cathode-ray tube in which a decrease in color purity is small.

In the second related art, the start time of vapor deposition of manganese differs from that of aluminum. It is difficult to form the heat absorbing film 14 having a desired quality, and accordingly it is difficult to manufacture a color cathode-ray tube in which a decrease in color purity is small. In the third related art, the carbon film serving as the heat absorbing film 14 tends to separate easily due to its low adhesion properties, and has large gas absorption properties. Nonuniformity occurs in the image quality, and the cathode of the electron gun is damaged by a decrease in vacuum degree in the color cathode-ray tube. Therefore, it is difficult to manufacture a color cathode-ray tube having a uniform image quality and a long service life.

It is, therefore, an object of the present invention to provide a color cathode-ray tube in which variations in thickness and quality of a heat absorbing film on a conductive reflecting film are small so that a decrease in color purity is small, and a method of manufacturing the same.

### DISCLOSURE OF INVENTION

With a color cathode-ray tube and a method of manufacturing the same according to the present invention, a sol containing a material, which is to form an oxide, in a colloidal state is applied and baked to form a heat absorbing film made of the oxide on a conductive reflecting film. The conductive reflecting film is generally formed by vacuum deposition. Namely, a method of forming the conductive reflecting film and a method of forming the heat absorbing film are different from each other, and a vacuum evaporation system for forming the conductive reflecting film and an applying/baking system for forming the heat absorbing film are two different systems.

Therefore, conditions under which these systems are operated need not be changed, and a heat absorbing film having small variations in thickness and quality can be formed on the conductive reflecting film. Reflection and radiation of heat from the conductive reflecting film to a color selection electrode are suppressed effectively, and mislanding of an electron beam onto a phosphor screen caused by thermal expansion of the color selection electrode is suppressed, so that a color cathode-ray tube in which a decrease in color purity is small can be manufactured.

As the material to form the oxide, if at least one member selected from a group consisting of silicon, manganese, aluminum and tin antimonide is used, a heat absorbing film, having large adhesion properties to prevent easy separation, and small gas absorption properties, can be formed on the conductive reflecting film. Therefore, nonuniformity does not occur easily in the image quality, and the cathode of the electron gun is not easily damaged by a decrease in vacuum degree in the color cathode-ray tube. Therefore, a color cathode-ray tube having a uniform image quality and a long service life can be manufactured.

When a sol dispersed with fine carbon powder is used, a heat absorbing film having a high heat absorption-effect can be formed. Then, mislanding of the electron beam to the phosphorus surface caused by thermal expansion of the color selection electrode is suppressed further effectively, so that a color cathode-ray tube in which a decrease in color purity is further small can be manufactured.

### BRIEF DESCRIPTION OF DRAWING

FIG. 1 is a side sectional view of a panel to which the present invention can be applied.

### BEST MODE FOR CARRYING OUT THE INVENTION

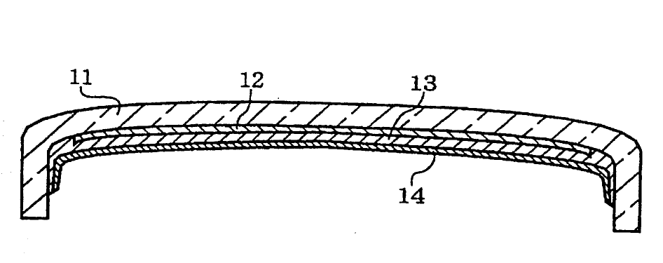

An embodiment of the present invention will be described with reference to FIG. 1. In this embodiment, in a panel 11, an organic intermediate film (not shown) is formed on the surface of a phosphor screen 12 to smooth the surface of the phosphor screen 12. This panel 11 is placed on the base of a vacuum evaporation system, and aluminum as the material of a conductive reflecting film 13 is set on the heater of the vacuum evaporation system. The interior of the vacuum evaporation system is evacuated by an oil rotation pump and an oil diffusion pump.

When the interior of the vacuum evaporation system reaches a vacuum degree of about 10⁻² to 10⁻³ Pa (10⁻⁴ to 10⁻⁵ Torr), power is supplied to the heater to deposit aluminum by heat vapor deposition, thereby forming the conductive reflecting film 13 on the phosphor screen 12. In this vacuum vapor deposition, the conductive reflecting film 13 having a uniform thickness can be formed, and the conductive reflecting film 13 can be formed within a short period of time, i.e., at a low cost. After that, the panel 11 is held at a temperature equal to or more than ordinary temperature in a heating furnace.

A sol containing at least one member selected from the group consisting of silicon, manganese, aluminum and tin antimonide in a colloidal state is generated by hydrolysis of an alkoxide. The panel 11 is removed from the heating furnace, and the sol is uniformly applied to the conductive reflecting film 13 by spraying or the like. The panel 11 is heated in a heating furnace different from that described above to perform a baking for evaporating the organic intermediate film to form the conductive reflecting film 13 in a specular state. This baking is performed simultaneously with a baking for forming a heat absorbing film 14 made of an oxide of a material, in the applied sol, which is in the colloidal state Since the panel 11 is held at a temperature equal to or more than ordinary temperature before applying the sol, the dispersion medium of the applied sol evaporates easily. As a result, the heat absorbing film 14 having uniform thickness and quality can be formed. If fine carbon powder is dispersed in a sol, particularly a sol containing silicon in a colloidal state, a heat absorbing film 14 having a further high heat absorption effect can be formed.

In the above embodiment, the material of the colloid is selected from silicon, manganese, aluminum and tin antimonide. The material of the colloid can be selected from other materials as far as it can form the heat absorbing film 14 with an oxide. In the above embodiment, the sol is generated by hydrolysis of an alkoxide. However, the sol can be generated by other methods.

### INDUSTRIAL APPLICABILITY

The present invention can be utilized in the manufacture of a color cathode-ray tube by applying it to formation of a heat absorbing film onto a conductive reflecting film on the phosphor screen on the inner surface of the panel.

1. A method of manufacturing a color cathode-ray tube, comprising the steps of:
applying a sol containing a material, which is to form an oxide, in a colloidal state on a conductive reflecting film on a phosphor screen of an inner surface of a panel; and
baking the sol to form a heat absorbing film made of the oxide on said conductive reflecting film.

2. A method of manufacturing a color cathode-ray tube according to claim 1, wherein at least one member selected from a group consisting of silicon, manganese, aluminum and tin antimonide is used as the material.

3. A method of manufacturing a color cathode-ray tube according to claim 2, wherein the sol dispersed with fine carbon powder is used.

4. A color cathode-ray tube in which a heat absorbing film made of an oxide is formed on a conductive reflecting film on a phosphor screen of an inner surface of a panel by applying and baking a sol containing a material, which is to form the oxide, in a colloidal state.

5. A color cathode-ray tube according to claim 4, wherein the material is at least one member selected from a group consisting of silicon, manganese, aluminum and tin antimonide.

6. A color cathode-ray tube according to claim 5, wherein the sol is dispersed with the fine carbon powder.
